(19) United States
(12) Patent Application Publication
(10) Pub. No.: US 2004/0246702 A1
(43) Pub. Date: Dec. 9, 2004

(54) Light casing structure with yellow light area and its manufacture method

(76) Inventor: Chia-Ching Yeh, Tao Yuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/453,491

(22) Filed: Jun. 4, 2003

(51) Int. Cl. F21V 9/16; F21K 2/00

(52) U.S. Cl. 362/84; 362/293; 362/260

(57) ABSTRACT

A light casing structure with yellow light area includes a transparent casing and a yellow preparation uniformly sprayed on a surface of the transparent casing, thereby to absorb the light source of under 500 nm wavelength, so that it can completely cut off the ultraviolet, and it also can provide some effects, as the environmental protection, the power saving and the mosquito repelling.

### BACKGROUND OF THE INVENTION

(1). Field of The Invention

The present invention relates to an illuminated device, and in particularly to an illuminated device having a light casing structure with yellow light area for semiconductor or integrated circuit factory.

(2). Description of the Related Art

Please refer to FIG. 1, which illustrates a fluorescent lamp la including a glass tube 10a having a fluorescent material 15a coated on an inner wall thereof, filaments 11a disposed at two ends thereof wherein the filament 11a has a duplicate wrap or triple wrap of electrode and an electronic radiation material spread thereon. However, the fluorescent lamp, la has 2.33 torr of argon gas and proper capacity of quicksilver installed therein in order to discharge electricity easily. Furthermore, in the action principle due to the fluorescent lamp 1a, i.e. when it is switched, the electrode (negative pole) is previously heated by an electric current, thereby to discharge a large number of thermo electrons 12a in the tube, and the thermo electrons 12a will be guided to another electrode (positive pole) thereby to start to discharge. However, the thermo electrons 12a will collide with quicksilver electrons 13a, thereby to generate ultraviolet rays 14a (253.7 nm), and the ultraviolet rays 14a will excite the fluorescent material 15a to transform as visible light 16a.

Additionally, shown as FIG. 2, the visible light 16a has a wavelength scope at 380 nm˜760 nm (wherein the yellow light has a wavelength scope at 500 nm˜580 nm), and the ultraviolet has a wavelength scope at under 380 nm. However, the ultraviolet will cause the sensitive material in semiconductor field to generate the reaction, hence the illuminated equipment used in semiconductor or integrated circuit factory with the sensitive material, it will provide a layer yellow PE film 2a on the glass tube 10a of the fluorescent lamp 1a, so that the yellow PE film 2a can cut off the light of under 500 nm wavelength thereby to prevent the sensitive material from generating the reaction. Another, the yellow PE film 2a will provide a protected function, i.e. when the glass tube is broke in the accident, the glass fragment and the fluorescence powder will not be scattered everywhere and pollute the environment. However, the yellow PE film 2a will cause the color fading and to go bad, and it cannot be recycled thereby to fail to provide an environmental protection function.

### SUMMARY OF THE INVENTION

The primary purpose of the present invention is to provide a light casing structure with yellow light area and its manufacture method which uses a yellow preparation made of an organic polymer to spray on an inner or an outer surface of a glass tube for obtaining an uniform yellow area, thereby to absorb light source of under 500 nm wavelength, so that it can completely cut off the ultraviolet, and it also has some effects, as the environmental protection, the power saving, and the mosquito and bug repelling.

In accordance with one aspect of the present invention, to provide a light casing structure with yellow light area and its manufacture method, wherein the light casing structure includes a transparent casing and a yellow preparation uniformly sprayed on an inner or an outer surface of the transparent casing. Furthermore, the manufacture method of the light casing structure includes the steps of: blending a dense liquid according to constituents of a yellow preparation, and placing the dense liquid into a sprayed device; placing a transparent casing of the light casing structure on a sprayed space, spraying the dense liquid on a surface of the transparent casing through a nozzle of the sprayed device, and placing the transparent casing in an oven for baking the dense liquid to harden.

### BRIEF DESCRIPTION OF THE DRAWINGS

Other objects, features and advantages of the present invention will be more apparent from the following detailed description when read in conjunction with the accompanying drawings in which:

FIG. 1 is a sketched view of a fluorescent lamp due to a prior art;

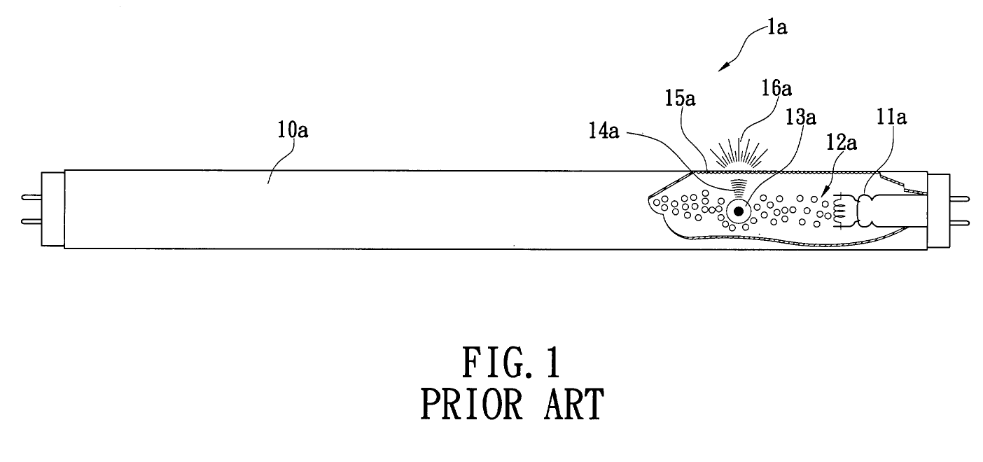

FIG. 2 is a sketched view of a fluorescent lamp used to a semiconductor or an integrated circuit factory due to another prior art;

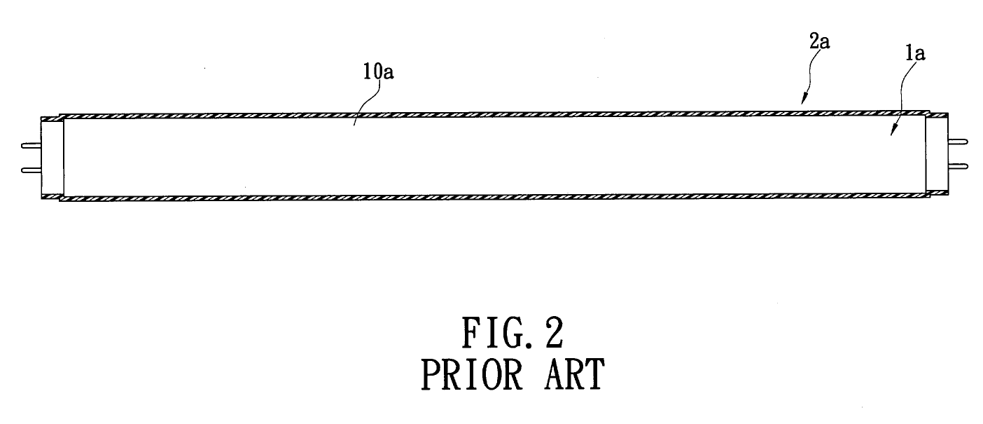

FIG. 3 is a sketched view of a light casing structure with yellow light area of a first embodiment due to the present invention;

FIG. 4 is a sketched view of the light casing structure with yellow light area of a second embodiment due, to the present invention;

FIG. 5 is a sketched view of the light casing structure with yellow light area of a third embodiment due to the present invention;

FIG. 6 is a flow diagram illustrating a manufacture method of the light casing structure with yellow light area due to the present invention; and

FIG. 7 is a flow diagram illustrating a manufacture method of another embodiment due to the present invention.

### DETAILED DESCRIPTION OF THE PREFERRED EMBODIMENT

A description will now be given of the preferred embodiments of the present invention with reference to the accompanying drawings.

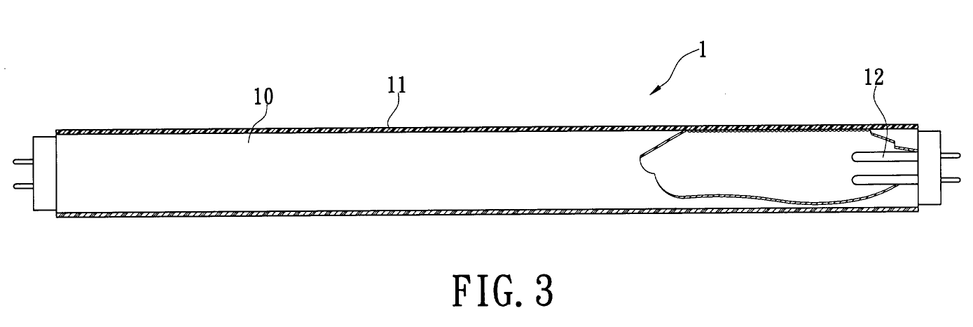

Referring to FIGS. 3 to 5, the present invention provides a light casing structure with yellow light area of an illuminated device used to semiconductor or integrated circuit (IC) factory, wherein the illuminated device can be a fluorescent lamp 1, a fluorescent bulb 2, or a window glass 3 of a house or a car, etc.

The fluorescent lamp 1 (shown as FIG. 3) includes a transparent casing (like a glass tube 10), a yellow preparation 11 uniformly sprayed on a surface of the glass tube 10 and a luminescent source 12 arranged within the glass tube 10 (or the other light source). However, the yellow preparation 11 sprayed around the glass tube 10 will prevent ultraviolet from being diffused outwardly from an inner of the glass tube 10 for cutting off the ultraviolet of under 500 nm wavelength, thereby to only enable the light source of above 500 nm wavelength to be penetrate out. Furthermore, the yellow preparation 11 is a kind of yellow transparent dense liquid, and the dense liquid is constituted by components and its percentage of weight, as follows:

| COMPONENT | PERCENTAGE OF WEIGHT |
|---|---|
| glycidoxypropyltrimethoxysilane | 28.0˜52.0 |
| (GPTMS) | |
| resin (E-114) | 13.0˜19.0 |
| isopropyl (IPA) | 0.1˜0.2 |
| nitric acid | 1.0˜1.6 |
| propyl alcohol zirconium | 11.0˜15.0 |
| yellow dyestuff | 1.2˜1.6 |
| ethyl acetate | 0.2˜0.4 |
| sodium hydroxide | 0.1˜0.3 |
| sodium chloride | 0.01˜0.05 |
| Ethanol | 16.0˜22.0 |
| methyl alcoho | 0.8˜1.1 |
| Hardener | 0.5˜0.7 |
| pure water | 3.0˜9.0 |

Wherein the dense liquid is constituted by the components and its preferred percentage of weight, as follows:

| COMPONENT | PERCENTAGE OF WEIGHT |
|---|---|
| glycidoxypropyltrimethoxysilane | 40.0 |
| (GPTMS) | |
| resin (E-114) | 17.0 |
| isopropyl (IPA) | 0.15 |
| nitric acid | 1.3 |
| propyl alcohol zirconium | 14.0 |
| yellow dyestuff | 1.4 |
| ethyl acetate | 0.3 |
| sodium hydroxide | 0.2 |
| sodium chloride | 0.03 |
| Ethanol | 17.0 |
| methyl alcoho | 0.9 |
| Hardener | 0.6 |
| pure water | 7.1 |

Wherein the dense liquid is constituted by the components and its weight, as follows:

| COMPONENT | PERCENTAGE OF WEIGHT |
|---|---|
| glycidoxypropyltrimethoxysilane | 16.0 |
| (GPTMS) | |
| resin (E-114) | 6.8 |
| isopropyl (IPA) | 0.06 |
| nitric acid | 0.52 |
| propyl alcohol zirconium | 5.6 |
| yellow dyestuff | 0.56 |
| ethyl acetate | 0.12 |
| sodium hydroxide | 0.08 |
| sodium chloride | 0.01 |
| Ethanol | 6.8 |
| methyl alcoho | 0.36 |
| Hardener | 0.24 |
| pure water | 2.85 |

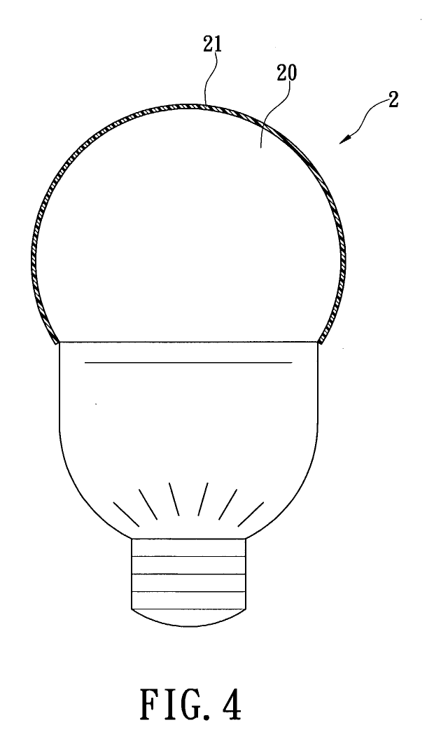

Furthermore, the fluorescent bulb 2 (shown as FIG. 4) includes a glass tube and a yellow preparation 21 uniformly sprayed on an inner or an outer surface of the glass tube 20, and the fluorescent bulb 2 has an exterior shape different from the glass tube 10 of the fluorescent lamp 1.

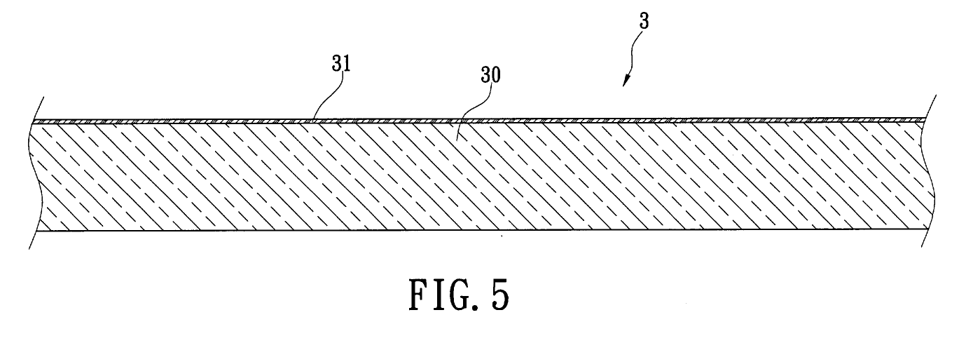

The window glass 3 (shown as FIG. 5) includes a glass plane 30 and a yellow preparation 31 uniformly sprayed on an inner or an outer surface of the glass plane 30, and the window glass 3 can installed the window of the house or car for preventing the ultraviolet from being illuminated from the sun.

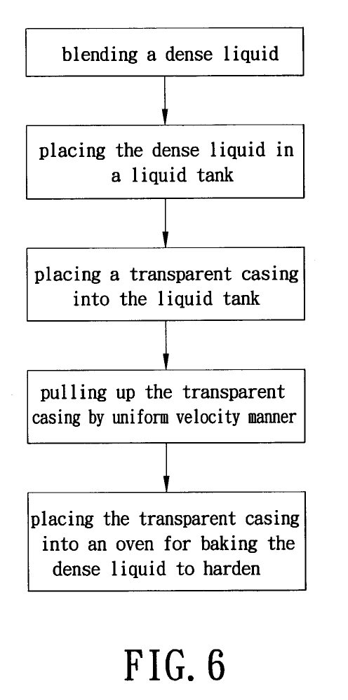

Please refer to FIG. 6, which is a flow diagram illustrating a manufacture method of the light casing structure with yellow light area due to the present invention, the manufacture method includes the steps of:

(1) the first, blending a dense liquid according to the components of the yellow preparation 11;

(2) placing the dense liquid in a liquid tank having an electroplate equipment;

(3) placing the transparent casing 10 into the liquid tank providing a temperature at 20˜50° C. in an inner thereof;

(4) pulling up the transparent casing 10 by an uniform velocity manner, so that the dense liquid coated on the transparent casing 10 having a thickness at 1˜10 μm and a viscosity at 20˜80 cp; and

(5) placing the transparent casing 10 into an oven for baking the dense liquid to harden.

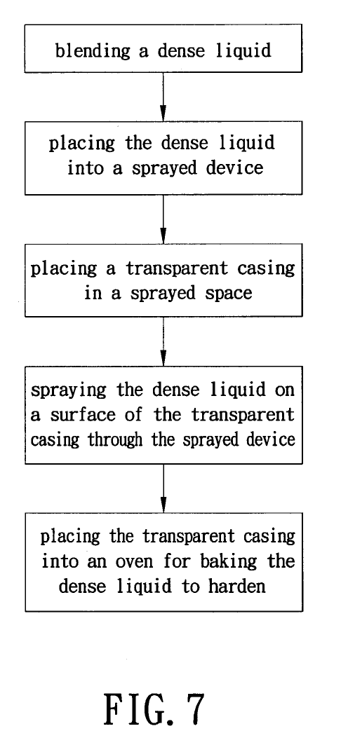

Please refer to FIG. 7, which is a flow diagram illustrating a manufacture method of another embodiment due to the present invention, the manufacture method includes the steps of:

(1) the first blending a dense liquid according to the components of the yellow preparation 11, and

(2) placing the dense liquid into a sprayed device providing a temperature at 20˜50° C. in an inner thereof, the sprayed device can be arranged on an automatic sprayed machine, or can be a manual airbrush;

(3) placing a transparent casing of the light casing structure in a sprayed space (it can be a space on a platform of the automatic sprayed machine);

(4) spraying the dense liquid on an inner or outer surface of the transparent casing through a nozzle of the sprayed device, wherein the dense liquid sprayed on the transparent casing 10 has a thickness at 1˜10 μm and a viscosity at 20˜80 cp; and

(5) placing the transparent casing 10 in an oven for baking the dense liquid to harden, wherein the oven controlling a temperature at 100˜160° C. in an inner thereof.

To sum up, it can provide the following advantages due to the present invention:

(1) the present invention can cut off the light source of under 500 nm wavelength, thereby to prevent the ultraviolet from being penetrate out.

(2) the yellow preparation in the surface of the glass tube can be the organic polymer, hence it will be able to be recycled, and provide an environmental protection effect.

(3) with regard to the yellow area of the present invention, it can provide a mosquito repelling effect.

(4) the present invention can be used at temperature of under 200° C., and not generate the color fading and to go bad.

Those skilled in the art will readily observe that numerous modification and alterations of the device may be made while retaining the teachings of the invention. Accordingly, the above disclosure should be construed as limited only by the metes and bounds of the appended claims.

What is claimed is:

1. A light casing structure with a yellow light area of an illuminated device used to a semiconductor or an integrated circuit factory, comprising
a transparent casing; and
a yellow preparation uniformly sprayed on a surface of the transparent casing.

2. The light casing structure in claim 1, wherein the illuminated device is a fluorescent lamp having a luminescent source.

3. The light casing structure in claim 1, wherein the illuminated device is a fluorescent bulb.

4. The light casing structure in claim 1, wherein the transparent casing is a glass tube.

5. The light casing structure in claim 1, wherein the yellow preparation is constituted of a glycidoxypropyltrimethoxysilane (GPTMS), a resin (E-114), an isopropyl (IPA), a nitric acid, a propyl alcohol zirconium, a yellow dyestuff, an ethyl acetate, a sodium hydroxide, a sodium chloride, an ethanol, a methyl alcohol, a hardener and a pure water.

6. A manufacture method of a light casing structure with a yellow light area, comprising the steps of:
(1) blending a dense liquid according to components of a yellow preparation, and placing the dense liquid into a sprayed device;
(2) placing a transparent casing of the light casing structure in a sprayed space;
(3) spraying the dense liquid on a surface of the transparent casing through a nozzle of the sprayed device; and
(4) placing the transparent casing in an oven for baking the dense liquid to harden.

7. The manufacture method in claim 6, wherein the sprayed device provides a temperature at 20˜50° C. in an inner thereof.

8. The manufacture method in claim 6, wherein the dense liquid sprayed on the transparent casing has a thickness at 1˜10 μm and a viscosity at 20˜80 cp.

9. The manufacture method in claim 6, wherein the oven controlles a temperature at 100˜160° C. in an inner thereof.
